(19) United States
(12) Patent Application Publication
(10) Pub. No.: US 2025/0142303 A1
(43) Pub. Date: May 1, 2025

(54) FLEXIBLE PLATOON CONTROL MESSAGING

(71) Applicant: QUALCOMM INCORPORATED, San Diego, CA (US)

(72) Inventors: Lan YU, Beijing (CN); Hong CHENG, Basking Ridge, NJ (US); Dan VASSILOVSKI, Del Mar, CA (US); Gene Wesley MARSH, San Diego, CA (US)

(21) Appl. No.: 18/683,418

(22) PCT Filed: Oct. 21, 2021
(86) PCT No.: PCT/CN2021/125258

§ 371 Date: Feb. 13, 2024

(51) Int. Cl. H04W 4/46; G08G 1/00

(52) U.S. Cl. CPC H04W 4/46; G08G 1/22

(57) ABSTRACT

Various aspects of the present disclosure generally relate to wireless communication. In some aspects, a transmitter mobile station may transmit at least one platoon control message (PCM) having a flexible structure, the at least one PCM comprising a first part and a second part that is different from the first part, wherein the first part comprises non-platoon-specific data elements and the second part comprises platoon-specific data elements. The transmitter mobile station may transmit at least one basic safety message (BSM). Numerous other aspects are described.

### FIELD OF THE DISCLOSURE

Aspects of the present disclosure generally relate to wireless communication and to techniques and apparatuses for flexible platoon control messaging.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a transmitter mobile station associated with a member vehicle of a vehicle platoon. The transmitter mobile station associated with a member vehicle of a vehicle platoon may include a memory and one or more processors coupled to the memory. The one or more processors may be configured to transmit at least one platoon control message (PCM) having a flexible structure, the at least one PCM comprising a first part and a second part that is different from the first part, wherein the first part comprises non-platoon-specific data elements and the second part comprises platoon-specific data elements. The one or more processors may be configured to transmit at least one basic safety message (BSM).

Some aspects described herein relate to a receiver mobile station for wireless communication. The receiver mobile station may include a memory and one or more processors coupled to the memory. The one or more processors may be configured to receive at least one PCM having a flexible structure, the at least one PCM comprising a first part and a second part that is different from the first part, wherein the first part comprises non-platoon-specific data elements and the second part comprises platoon-specific data elements. The one or more processors may be configured to receive at least one BSM.

Some aspects described herein relate to a method of wireless communication performed by a transmitter mobile station associated with a member vehicle of a vehicle platoon. The method may include transmitting, by the transmitter mobile station to at least one additional member vehicle of the vehicle platoon, at least one PCM having a flexible structure, the at least one PCM comprising a first part and a second part that is different from the first part, wherein the first part comprises non-platoon-specific data elements and the second part comprises platoon-specific data elements. The method may include transmitting, by the transmitter mobile station, at least one BSM.

Some aspects described herein relate to a method of wireless communication performed by a receiver mobile station associated with a member vehicle of a vehicle platoon. The method may include receiving, by the receiver mobile station from at least one additional member vehicle of the vehicle platoon, at least one PCM having a flexible structure, the at least one PCM comprising a first part and a second part that is different from the first part, wherein the first part comprises non-platoon-specific data elements and the second part comprises platoon-specific data elements. The method may include receiving, by the receiver mobile station from the at least one additional member vehicle of the vehicle platoon, at least one BSM.

Some aspects described herein relate to a non-transitory computer-readable medium that stores a set of instructions for wireless communication by a vehicle platoon. The set of instructions, when executed by one or more processors of the vehicle platoon, may cause the vehicle platoon to transmit at least one PCM having a flexible structure, the at least one PCM comprising a first part and a second part that is different from the first part, wherein the first part comprises non-platoon-specific data elements and the second part comprises platoon-specific data elements. The set of instructions, when executed by one or more processors of the vehicle platoon, may cause the vehicle platoon to transmit at least one BSM.

Some aspects described herein relate to a non-transitory computer-readable medium that stores a set of instructions for wireless communication by a vehicle platoon. The set of instructions, when executed by one or more processors of the vehicle platoon, may cause the vehicle platoon to receive at least one PCM having a flexible structure, the at least one PCM comprising a first part and a second part that is different from the first part, wherein the first part comprises non-platoon-specific data elements and the second part comprises platoon-specific data elements. The set of instructions, when executed by one or more processors of the vehicle platoon, may cause the vehicle platoon to receive at least one BSM.

Some aspects described herein relate to an apparatus associated with a member vehicle of a vehicle platoon. The apparatus may include means for transmitting at least one PCM having a flexible structure, the at least one PCM comprising a first part and a second part that is different from the first part, wherein the first part comprises non-platoon-specific data elements and the second part comprises platoon-specific data elements. The apparatus may include means for transmitting at least one BSM.

Some aspects described herein relate to an apparatus associated with a member vehicle of a vehicle platoon. The apparatus may include means for receiving at least one PCM having a flexible structure, the at least one PCM comprising a first part and a second part that is different from the first part, wherein the first part comprises non-platoon-specific data elements and the second part comprises platoon-specific data elements. The apparatus may include means for receiving at least one BSM.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of vehicle platooning, in accordance with the present disclosure.

FIGS. 4 and 5 are diagrams illustrating examples associated with flexible platoon control messaging, in accordance with the present disclosure.

FIGS. 6 and 7 are diagrams illustrating example processes associated with flexible platoon control messaging, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

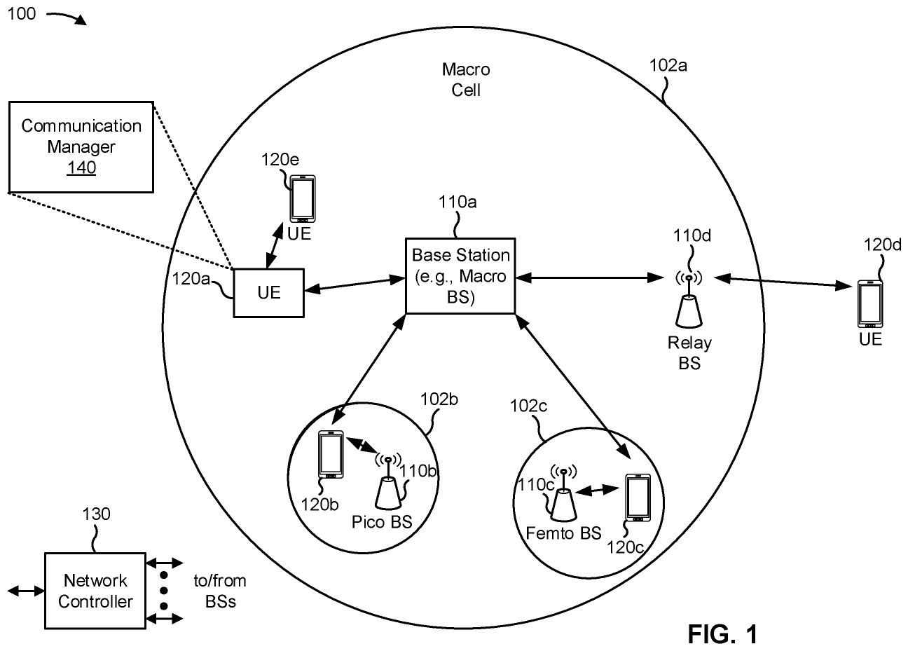

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the transmitter mobile station may include a communication manager 140. As described in more detail elsewhere herein, the communication manager 140 may transmit at least one platoon control message (PCM) having a flexible structure, the at least one PCM comprising a first part and a second part that is different from the first part, wherein the first part comprises non-platoon-specific data elements and the second part comprises platoon-specific data elements; and transmit at least one basic safety message (BSM). Additionally, or alternatively, the communication manager 140 may perform one or more other operations described herein.

In some aspects, the receiver mobile station may include a communication manager 140. As described in more detail elsewhere herein, the communication manager 140 may receive at least one PCM having a flexible structure, the at least one PCM comprising a first part and a second part that is different from the first part, wherein the first part comprises non-platoon-specific data elements and the second part comprises platoon-specific data elements; and receive at least one BSM. Additionally, or alternatively, the communication manager 140 may perform one or more other operations described herein.

As indicated above, FIG. 1 is provided as an example. Other examples may differ from what is described with regard to FIG. 1.

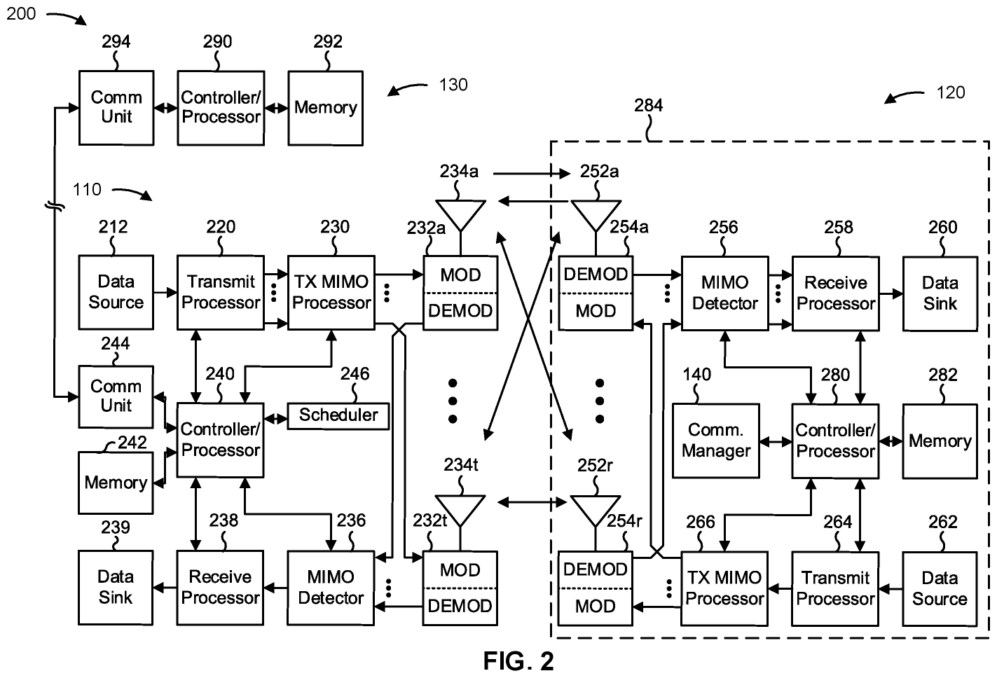

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

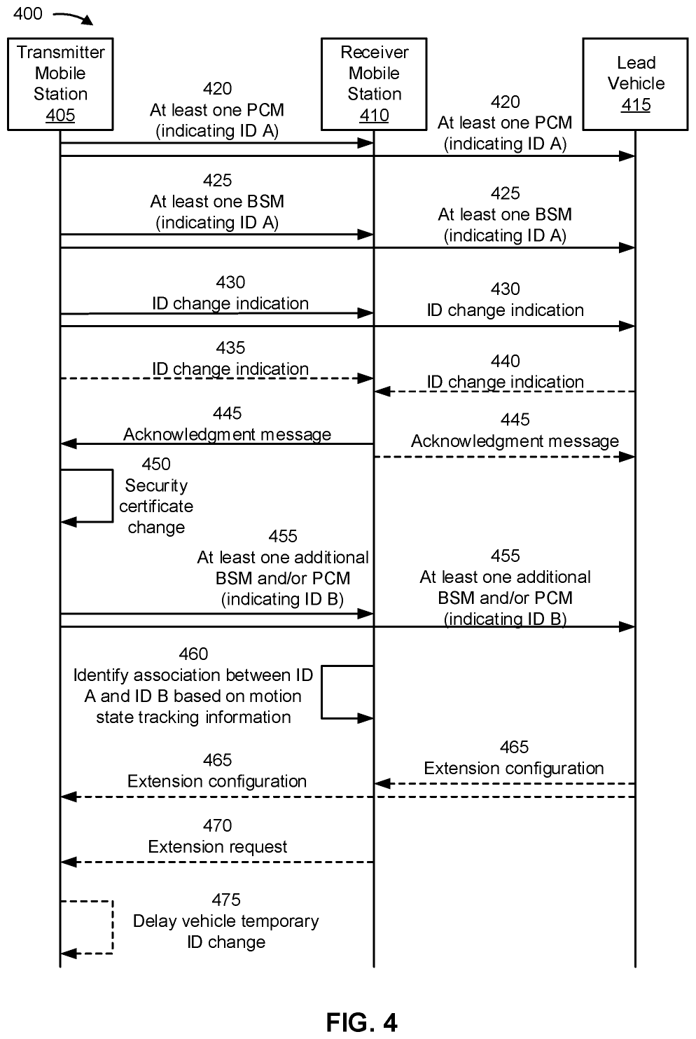

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

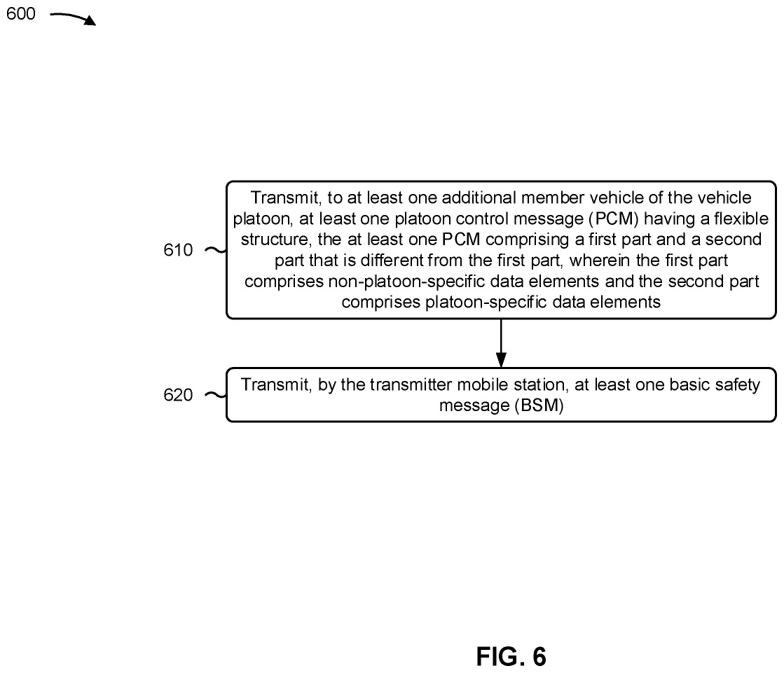

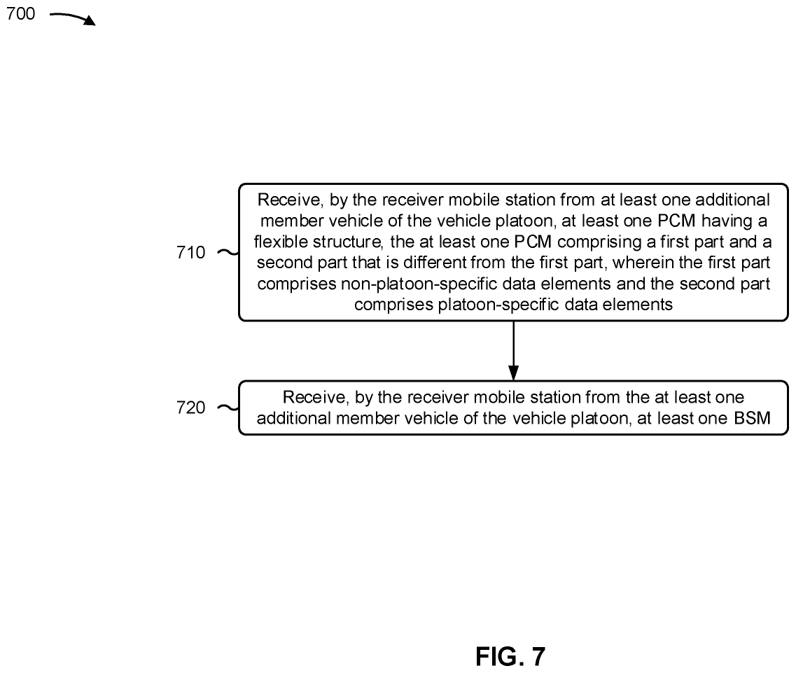

The controller/processor 240 of the base station 110, the controller/processor 280 of the UE 120, and/or any other component(s) of FIG. 2 may perform one or more techniques associated with flexible platoon control messaging, as described in more detail elsewhere herein. In some aspects, the mobile station (including, for example, the transmitter mobile station and the receiver mobile station) described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a transmitter mobile station associated with a member vehicle of a vehicle platoon includes means for transmitting, to at least one additional member vehicle of the vehicle platoon, at least one PCM having a flexible structure, the at least one PCM comprising a first part and a second part that is different from the first part, wherein the first part comprises non-platoon-specific data elements and the second part comprises platoon-specific data elements; and/or means for transmitting, by the transmitter mobile station, at least one BSM. In some aspects, the means for the transmitter mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the receiver mobile station associated with a member vehicle of a vehicle platoon includes means for receiving, from at least one additional member vehicle of the vehicle platoon, at least one PCM having a flexible structure, the at least one PCM comprising a first part and a second part that is different from the first part, wherein the first part comprises non-platoon-specific data elements and the second part comprises platoon-specific data elements; and/or means for receiving, by the receiver mobile station from the at least one additional member vehicle of the vehicle platoon, at least one BSM. In some aspects, the means for the receiver mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Wireless communication systems may include or support networks used for vehicle based communications, also referred to as vehicle-to-everything (V2X) networks, vehicle-to-vehicle (V2V) networks, and/or cellular V2X (C-V2X) networks, among other examples. Vehicle based communication networks may provide always on telematics where UEs, such as vehicle UEs (v-UEs), communicate directly to the network (V2N); to pedestrian UEs, via vehicle-to-pedestrian (V2P) communications; to infrastructure devices, via vehicle-to-infrastructure (V2I) communications; and to other v-UEs (e.g., via the network and/or directly). The vehicle-based communication networks may support a safe, always-connected driving experience by providing intelligent connectivity where information is exchanged. The exchanged information can include traffic signal/timing information, real-time traffic and routing information, safety alerts to pedestrians/bicyclists, and/or collision avoidance information, among other examples.

One example of such vehicle-based communication networks may support platooning, which coordinates the movement of a group of vehicles (a group of platooning vehicles, which may be referred to as a “platoon” or a “vehicle platoon”) to reduce the inter-vehicle distance, improve lane capacity, reduce drag, and/or increase fuel efficiency, among other examples. To maintain the stability of vehicle-following operations performed by member vehicles (vehicles belonging to a vehicle platoon), such as, for example, to keep constant spacing between platooning vehicles, a vehicle in the platoon typically sends its own position/location, speed, acceleration, and other such information to adjacent vehicles. A vehicle may also share this information to the other vehicles in the platoon of vehicles to help stabilize the platoon of vehicles. Such intra-platoon (or inter-vehicle) communications are wireless communications with radio resources, which can be managed efficiently to avoid interference and collision.

Groups of platooning vehicles may be formed on an ad-hoc basis depending on V2V information exchanged between the vehicles and/or V2X information exchanged between the vehicles and the base station/network, among other examples. For example, a platoon of vehicles may be dynamically formed whenever a certain number of vehicles are traveling in the same direction (e.g., in the same or adjacent lanes of traffic) and/or at roughly the same speed to achieve certain advantages, such as improved fuel efficiency, more efficient traffic flow, and/or improved collision avoidance, among other examples. Moreover, vehicles may leave the platoon and/or be added to the group of platooning vehicles as needed. Coordination of the group of platooning vehicles may use wireless communications, such V2V communications, V2X communications, and/or V2I communications, among other examples.

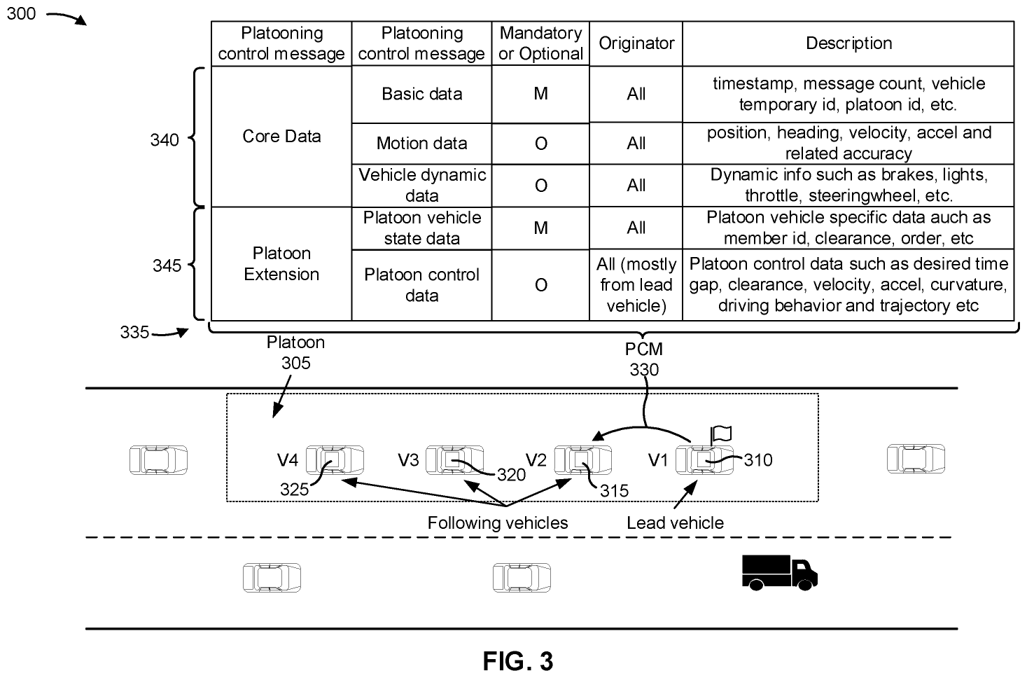

FIG. 3 is a diagram illustrating an example 300 of vehicle platooning, in accordance with the present disclosure. As shown in FIG. 3, a vehicle platoon 305 may include a number of member vehicles V1, V2, V3, and V4. The member vehicle V1 may be referred to as the “lead vehicle” of the vehicle platoon 305. Each of the member vehicles may be, or include, a mobile station 310, 315, 320, and 325, respectively. The mobile station 310, 315, 320, and/or 325 may be, include, or be included in a UE (e.g., UE 120). Although the example 300 shows four vehicles in the vehicle platoon 305, it is to be understood that a vehicle platoon 305 may include more or fewer vehicles. Moreover, the number and order of vehicles within the vehicle platoon may change dynamically (e.g., depending upon traffic conditions, vehicles entering the roadway, and/or vehicles entering the roadway, among other examples).

References to a vehicle may generally refer to a mobile station associated with that vehicle, as is described herein. For example, a vehicle may be configured as a mobile station (e.g., UE 120) to perform wireless communications in a wireless communication system using any of the described and/or future wireless communication systems. The vehicle may support V2V wireless communications, V2X wireless communications, and/or V2I wireless communications, among other examples. However, it can also be appreciated that each vehicle may have different wireless communication capabilities (e.g., communication range and/or communication throughput capabilities, among other examples).

In some cases, the mobile station 310 of the lead vehicle V1 may determine a communication resource requirement for the group of platooning vehicles. The communication resource requirement may be determined based on the number of vehicles in the vehicle platoon 305 and a communication range of some or all of the vehicles in the vehicle platoon 305. The mobile station 310 may identify, based on the communication resource requirement, an assignment of time-frequency radio resources to use for inter-vehicle communications within the vehicle platoon 305. The mobile station 310 may transmit an indication of the assigned time-frequency radio resources to the other mobile stations 315, 320, and 325 associated with the other member vehicles V2, V3, and V4, respectively, in the platoon.

To facilitate platooning operations of the member vehicles of the platoon 305, periodic messages can be transmitted between the member vehicles. The periodic messages can be, for example, PCMs and can be used, for example, to update status information corresponding to the member vehicles. In some cases, a PCM also may include information elements designed to facilitate safety. In addition, information that facilitates coordination and control of maneuvering within the vehicle platoon can be included in a PCM. However, nearby V2X entities (e.g., vehicles that are not member vehicles of the platoon 305) can periodically broadcast BSMs that include real-time status information to facilitate driving safety. Because of the short distance of transmission for PCMs, some of the key performance indicator (KPI) requirements of PCMs may be different than the KPI requirements for BSMs. For example, transmission frequency of a BSM can be 10 Hertz (Hz), whereas a transmission frequency for a PCM can be 20 Hz. Additionally, many of the information elements carried by PCMs also are carried in BSMs. For example, both types of messages can carry information that indicates a speed of a member vehicle, a position of a member vehicle, and/or an acceleration of a member vehicle, among other examples. Accordingly, if a member vehicle transmits both PCMs and BSMs, there may be transmission redundancy and, as a result, transmitting PCMs and BSMs can have a negative impact on network efficiencies.

Additionally, due to privacy protection requirements, a vehicle temporary identifier (ID), which may be carried in a PCM and/or a BSM, can change over a variable length of time. Because PCM vehicle temporary IDs can be different than, and change in a manner unrelated to, BSM vehicle temporary IDs, association of a transmitting vehicle of a BSM with a transmitting vehicle of a PCM can be difficult, thereby making coordination of PCM transmission with BSM transmission difficult.

Some aspects of techniques and apparatuses described herein may facilitate coordination of PCM transmissions with BSM transmissions to reduce the redundancy of transmitted information. In some aspects, for example, a transmitter mobile station may transmit, to at least one additional member vehicle of a vehicle platoon, at least one PCM having a flexible structure. The at least one PCM may include a first part and a second part that is different from the first part. The first part may include non-platoon-specific data elements and the second part may include platoon-specific data elements. The flexible structure of the PCM may facilitate reducing information redundancy between the at least one PCM and the at least one BSM. The transmitter mobile station also may transmit at least one basic safety message using a cooperative transmission scheme to transmit the at least one PCM and the at least one BSM. The cooperative transmission scheme may facilitate associating the transmitter of the at least one PCM and the transmitter of the at least one BSM, thereby facilitating coordination of PCM transmissions with BSM transmissions.

For example, as shown by reference number 330, V1 may transmit a PCM to V2. The PCM may include a flexible structure 335. As shown, the flexible structure 335 may include a first part 340 and a second part 345 that is different from the first part 340. The first part comprises non-platoon-specific data elements and the second part comprises platoon-specific data elements. As shown, for example, the non-platoon-specific data elements may include a set of basic data elements (shown as “Basic data”), a set of motion data elements associated with the member vehicle (shown as “Motion data”), and a set of vehicle dynamic data elements associated with the member vehicle (shown as “Vehicle dynamic data”).

In some aspects, as shown, the set of basic data elements may indicate a timestamp associated with the at least one PCM, a message count associated with the at least one PCM, a vehicle temporary ID associated with the member vehicle, and/or a platoon ID associated with the vehicle platoon, among other examples. The set of motion data elements may indicate a position of the member vehicle, a heading of the member vehicle, a velocity of the member vehicle, and/or an acceleration of the member vehicle, among other examples. In some aspects, as shown in FIG. 3, the non-platoon-specific data elements may include an accuracy level associated with one or more data elements of the set of motion data elements. The set of vehicle dynamic data elements may indicate a brake status associated with the member vehicle, a light status associated with the member vehicle, a throttle status associated with the member vehicle, and/or a steering status associated with the member vehicle, among other examples.

As shown in FIG. 3, the platoon-specific data elements may include a set of platoon vehicle state data elements associated with the member vehicle (shown as “Platoon vehicle state data”) and/or a set of platoon control data elements (shown as “Platoon control data”), among other examples. In some aspects, for example, the lead vehicle V1 may transmit at least a portion of the set of platoon control data elements to the other member vehicles. As shown, the set of platoon vehicle state data elements associated with the member vehicle may indicate a vehicle member identifier associated with the member vehicle, a distance between the member vehicle and an adjacent vehicle of the at least one additional member vehicle, and/or a relative platoon position of the member vehicle with respect to the at least one additional member vehicle, among other examples. The set of platoon control data elements may indicate a target time gap associated with the vehicle platoon, a target clearance associated with the vehicle platoon, a target acceleration associated with the vehicle platoon, a target curvature associated with the vehicle platoon, a target behavior associated with the vehicle platoon, and/or a target trajectory associated with the vehicle platoon, among other examples.

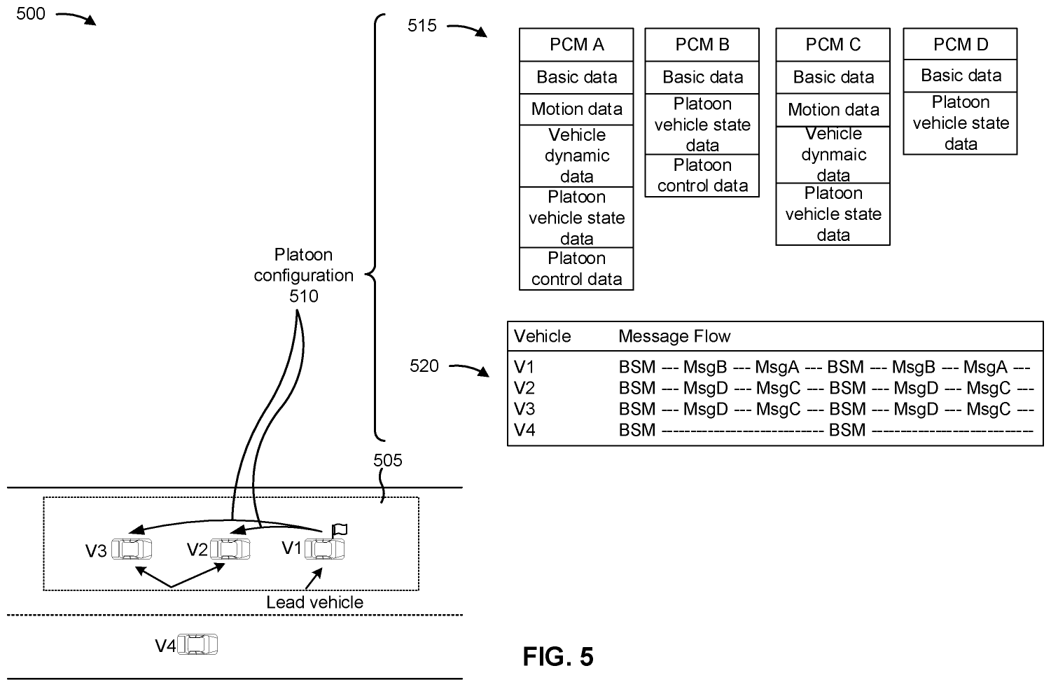

In some aspects, the illustrated structure of the PCM may be flexible. For example, in some aspects, a first PCM may include a first subset of the sets of data elements and a second PCM may include a second subset of the sets of data elements, as explained in further detail below in connection with FIGS. 4 and 5.

As indicated above, FIG. 3 is provided as an example. Other examples may differ from what is described with respect to FIG. 3.

FIG. 4 is a diagram illustrating an example 400 associated with flexible platoon control messaging, in accordance with the present disclosure. As shown in FIG. 4, a transmitter mobile station 405 and a receiver mobile station 410 may communicate with one another. In some aspects, the transmitter mobile station 405 may be, include, or be included in a member vehicle of a vehicle platoon. For example the transmitter mobile station 405 may be, or be associated with, member vehicle V1, V2, V3, or V4 shown in FIG. 3. Similarly, the receiver mobile station 410 may be, include, or be included in a member vehicle of a vehicle platoon. For example, the receiver mobile station 410 may be, or be associated with, member vehicle V1, V2, V3, or V4 shown in FIG. 3. In some aspects, any number of additional transmitter mobile stations and/or receiver mobile stations may be implemented in example 400.

As is further shown, a lead vehicle 415 may communicate with the transmitter mobile station 405 and/or the receiver mobile station 410. In some aspects, the lead vehicle may include a leading vehicle in the vehicle platoon that includes transmitter mobile station 405 and receiver mobile station 410. For example, the lead vehicle 415 may be, or be similar to, member vehicle V1 in FIG. 3. The lead vehicle 415 may be, include, or be otherwise associated with, a mobile station.

As shown by reference number 420, the transmitter mobile station 405 may transmit, and the receiver mobile station 410 may receive, at least one PCM having a flexible structure. As shown, the at least one PCM may include a vehicle temporary ID element that indicates a first vehicle temporary ID (shown as “ID A”) associated with the transmitter mobile station 405 (e.g., associated with the member vehicle associated with the transmitter mobile station 405). As shown, the transmitter mobile station 405 may also transmit the at least one PCM to the lead vehicle 415. In some aspects, the transmitter mobile station 405 may transmit the at least one PCM by transmitting at least one groupcast communication comprising the at least one PCM. For example, in some aspects, a platoon application may be operated using NR-V2X, which may enable transmitting PCMs by groupcast with a higher efficiency than broadcast. The reliability of groupcast may be leveraged in the platoon scenario since the range requirement is generally the total length of the vehicle platoon, which is known to all member vehicles of the vehicle platoon.

In some aspects, as described above with reference to FIG. 3, the at least one PCM may include a first part and a second part that is different from the first part. The first part may include non-platoon-specific data elements and the second part may include platoon-specific data elements. In some aspects, to reduce transmission redundancy, the transmitter mobile station 405 may transmit the at least one PCM by transmitting a sequence of PCMs. The sequence of PCMs may include, for example, a first PCM that includes a first instance of a set of motion data elements and a first instance of a set of vehicle dynamic data elements. The transmitter mobile station 405 may transmit a second consecutive PCM that does not include an instance of the set of motion data elements and that does not include an instance of the set of vehicle dynamic data elements.

Then, the transmitter mobile station 405 may transmit a third consecutive PCM that includes a second instance of the set of motion data elements and a second instance of the set of vehicle dynamic data elements. In some aspects, the transmitter mobile station 405 may transmit, in addition to the third consecutive PCM or instead of the third consecutive PCM, a single BSM. The single BSM may include a second instance of the set of motion data elements and a second instance of the set of vehicle dynamic data elements. Each of the PCMs may include a set of basic data elements. For example, the basic data elements may indicate respective timestamps, message counts, vehicle temporary IDs (of the transmitting vehicle member), and/or platoon IDs, among other examples.

As shown by reference number 425, the transmitter mobile station 405 may transmit, and the receiver mobile station 410 may receive, at least one BSM. In some aspects, at least one data element of the first part of the PCM may be identical to at least one data element of the BSM. For example, as shown, the at least one BSM may include a vehicle temporary ID element that indicates the first vehicle temporary ID (“ID A”) associated with the transmitter mobile station 405. The vehicle temporary ID may be used by the receiver mobile station 410, for example, to identify the transmitter mobile station 405 as the common transmitter of both the at least one PCM and the at least one BSM. In some aspects, the at least one identical data element may include one or more motion data elements and/or one or more vehicle dynamic data elements, among other examples.

In some aspects, the transmitter mobile station 405 may transmit the at least one PCM using a first transmission frequency and may transmit the at least one BSM using a second transmission frequency that is different than the first transmission frequency. In this case, “transmission frequency” refers to a number of times that a message is transmitted within a specified period of time. In some aspects, the first transmission frequency may be higher than the second transmission frequency. For example, the transmitter mobile station 405 may transmit the at least one PCM using a transmission frequency of 20 Hz (e.g., the PCMs are transmitted 20 times per second). The transmitter mobile station 405 may transmit the at least one BSM using a transmission frequency of 10 Hz (e.g., the BSMs are transmitted 10 times per second).

Since the at least one PCM and the at least one BSM may include one or more identical data elements, the transmitter mobile station 405 may use a cooperative transmission scheme to transmit the at least one PCM and the at least one BSM, as explained in more detail below in connection with FIG. 5. In this way, the transmitter mobile station 405 may reduce transmission redundancy, while preserving the flow of information. For example, in some aspects, the transmitter mobile station 405 may transmit at least one PCM and at least one BSM by transmitting a sequence of messages comprising the at least one PCM and the at least one BSM. In some aspects, the transmitter mobile station 405 may transmit the sequence of messages by transmitting a first BSM of the at least one BSM; transmitting the at least one PCM after transmitting the first BSM; and transmitting a second BSM of the at least one BSM after transmitting the at least one PCM. In some aspects, the at least one PCM may include a specified set of data elements based at least in part on the member vehicle being the lead vehicle and, in some cases, the at least one PCM may include a different specified set of data elements based at least in part on the member vehicle being a following vehicle.

In some aspects, a security certificate (which may correspond to a vehicle temporary ID) of a V2X entity may be required (e.g., by regulations and/or wireless communication standards) to be changed after a specified length of time (referred to as a vehicle temporary ID duration). At the end of a vehicle temporary ID duration, the vehicle temporary ID indicated by BSMs also may be changed. To facilitate coordination of transmissions and identification of transmitting mobile stations, the vehicle temporary ID indicated by PCMs also may be changed. In some aspects, for example, the vehicle temporary ID duration may be five minutes or any other length of time. In some aspects, the vehicle temporary ID duration may be variable (e.g., the vehicle temporary ID duration may be based on one or more ID duration criteria).

For example, when a vehicle temporary ID duration associated with the transmitter mobile station 405 expires, the vehicle temporary ID associated with the transmitter mobile station 405 may be changed to an updated vehicle temporary ID. So that other member vehicles (e.g., receiver mobile station 410) in the vehicle platoon may track the change and associate the updated vehicle temporary ID with the transmitter mobile station 405, the transmitter mobile station 405 may inform one or more of the other member vehicles of the change.

For example, as shown by reference number 430, the transmitter mobile station 405 may transmit, and the receiver mobile station 410 may receive, an ID change indication that indicates the updated vehicle temporary ID. In some aspects, the transmitter mobile station 405 may transmit the ID change indication via a groupcast communication to the receiver mobile station 410 and/or the lead vehicle 415. In some aspects, as shown by reference number 435, the transmitter mobile station 405 may transmit, and the lead vehicle 415 may receive, a unicast communication comprising the ID change indication that indicates the updated vehicle temporary ID. As shown by reference number 440, the lead vehicle 415 may transmit, and the receiver mobile station 410 may receive, the ID change indication. The lead vehicle 415 may transmit the ID change indication via groupcast to all of the members of the vehicle platoon (e.g., via a groupcast transmission). In some aspects, any number of the ID change indication transmissions discussed above may be protected using security key information.

As shown by reference number 445, the receiver mobile station 410 may transmit, and the transmitter mobile station 405 may receive, an acknowledgement message. The acknowledgement message may indicate successful receipt of the ID change indication. In some aspects, for example, the acknowledgment message may be an access layer protocol unicast and/or groupcast transmission.

As shown by reference number 450, the transmitter mobile station 405 may perform a security certificate change. In some aspects, as part of the security certificate change, a new vehicle temporary ID may be assigned to the transmitter mobile station 405. For example, in some aspects, a platooning application instantiated on the transmitter mobile station 405 may change the vehicle temporary ID. In some aspects, the transmitter mobile station 405 may receive an indication of the updated vehicle temporary ID from another device such as the lead vehicle 415 and/or a base station, among other examples.

As shown by reference number 455, the transmitter mobile station 405 may transmit, and the receiver mobile station 410 may receive, at least one additional BSM that includes the updated vehicle temporary ID (shown as “ID B”) and/or at least one additional PCM that includes the updated vehicle temporary ID. As shown, the transmitter mobile station 405 may transmit, and the lead vehicle 415 may receive, at least one additional BSM that includes the updated vehicle temporary ID and/or at least one additional PCM that includes the updated vehicle temporary ID.

Upon receiving the at least one additional BSM and/or PCM, the receiver mobile station 410 may identify an association between the at least one additional BSM and/or at least one additional PCM and the at least one BSM that was transmitted prior to the security certificate change and/or the at least one PCM that was transmitted prior to the security certificate change. For example, in some aspects, the receiver mobile station 410 may identify an association between the vehicle temporary ID and the updated vehicle temporary ID (and thus identify an association between messages associated with the respective vehicle temporary IDs and/or transmitting mobile stations associated with the respective vehicle temporary IDs, among other examples). In some aspects, as indicated above, the receiver mobile station 410 may receive an ID change indication that indicates the updated vehicle temporary ID, in which case the receiver mobile station 410 may identify the association based on the received ID change indication. However, in some aspects, the transmitter mobile station 405 may not transmit an ID change indication (e.g., to increase security). In some aspects, mobile stations may be configured with other ways of identifying the association instead of, or in addition to, receiving the ID change indication.

In some aspects, as shown by reference number 460, the receiver mobile station 410 may identify the association based on motion state tracking information associated with the transmitter mobile station 405. For example, the receiver mobile station 410 may use values of a position data element indicated by BSMs and/or PCMs received from the transmitter mobile station 405 to track the transmitter mobile station 405. For example, the receiver mobile station 410 may determine a predicted position value based at least in part on motion data elements associated with the transmitter mobile station 405.

In some aspects, for example, the at least one PCM (transmitted before the security certificate change) and/or the at least one BSM (transmitted before the security certificate change) may include a prior position value corresponding to an initial time instance, T0, and the at least one additional PCM (transmitted after the security certificate change) and/or the at least one additional BSM (transmitted after the security certificate change) may include a subsequent position value corresponding to a subsequent time instance, T1. The receiver mobile station 410 may determine a predicted position value for the subsequent time instance T1 using a formula such as position at T1=position at T0+velocity*(T1−T0). In some aspects, the receiver mobile station 410 may identify the association based at least in part on a difference between the predicted position value and the subsequent position value satisfying an uncertainty condition.

In some aspects, positioning error may be larger than expected, due to weather conditions, road conditions, and/or global navigation satellite system (GNSS) performance, among other examples. As a result, the accuracy of identifying the association via motion state tracking may be impacted. To mitigate these effects, the receiver mobile station 410 may use information about the vehicle platoon to facilitate identification of the association. For example, in some aspects, the receiver mobile station 410 may determine a platoon boundary based on a size of the vehicle platoon (e.g., the number of member vehicles in the platoon) and a position of the lead vehicle 415. Using the platoon boundary, the receiver mobile station 410 may identify the transmitting mobile station of a received PCM or BSM by identifying the member vehicle corresponding to a closest predicted position value to the subsequent position value indicated in the received PCM or BSM.

For example, the lead vehicle 415 may transmit, and the receiver mobile station 410 may receive, an indication of a size of the vehicle platoon and an indication a position of the lead vehicle 415. In some aspects, for example, the lead vehicle 415 may transmit one or more PCMs that include the indication of the size of the platoon and the indication of the position of the lead vehicle 415. The receiver mobile station 410 may identify a member vehicle that corresponds to a closest predicted position, of a plurality of predicted positions, to a position value indicated by the at least one additional BSM (received after the security certificate change). In some aspects, additional information may be used to facilitate identification of the association. For example, in some aspects, the motion state tracking information may include an indication of a lane index associated with the vehicle platoon. The receiver mobile station 410 may use the lane index and/or map information to facilitate tracking the motion of the transmitter mobile station 405.

In some aspects, ID change criteria may be configured to facilitate more accurate identification of the association between the vehicle temporary ID and the updated vehicle temporary ID. In some aspects, according to vehicle temporary ID management rules, the vehicle temporary ID element in BSMs may be randomly reinitialized when a security certificate changes upon expiration of a vehicle temporary ID duration. In some aspects, there may be exceptions for certificate change. For example, the vehicle temporary ID management rules may indicate that a security certificate may not change if one or more critical events are indicated in one or more BSMs and/or if the position of the corresponding mobile station does not change more than a specified threshold since the last security certificate change. However, the distance gap between platoon vehicles may be much smaller than free vehicles. Thus, the reliability requirements and delay requirements of motion status tracking within a vehicle platoon may be more stringent. Accordingly, in some aspects, certificate change rules may be extended to allow a vehicle temporary ID to persist for a longer time, thereby enhancing the ability of member vehicles to track the motion of the corresponding member vehicle.

For example, as shown by reference number 465, the lead vehicle 415 may transmit, and the receiver mobile station 410 may receive, an extension configuration. As shown, the lead vehicle may transmit the extension configuration to the transmitter mobile station 405. In some aspects, for example, the lead vehicle 415 may broadcast or groupcast the extension configuration to all of the member vehicles of the vehicle platoon. The extension configuration may indicate one or more rules (and/or may enable and/or disable previously-configured rules) that may facilitate extension of vehicle temporary IDs. In some aspects, for example, the extension configuration may indicate one or more ID extension conditions. An ID extension condition is a condition that may trigger a mobile station to extend a vehicle temporary ID duration and/or to request an extension of a vehicle temporary ID duration. An ID extension condition may be associated with a velocity and/or acceleration of one or more member vehicles of a vehicle platoon, a curvature of a road upon which the vehicle platoon is traveling, a traffic condition, a weather condition, a processing capability of a member vehicle, and/or planned route information, among other examples.

For example, in some aspects, if a member vehicle detects that its current motion state may cause other platoon members (e.g., the following vehicle) to have difficulty in accurately predicting a position of the member vehicle, the member vehicle may extend a vehicle temporary ID duration. For example, when the member vehicle is accelerating or decelerating, or when the vehicle is travelling on a curving road, the member vehicle may be configured to not change its vehicle temporary ID. The extension configuration may be applied to one or more certain member vehicles of a platoon or to all of the member vehicles of the platoon. In some aspects, the lead vehicle 415 may transmit the extension configuration in response to an extension request. In some aspects, the extension configuration may indicate ID extension conditions associated with triggering extension requests.

For example, as shown by reference number 470, the receiver mobile station 410 may transmit, and the transmitter mobile station 405 may receive, an extension request. The extension request may include a request for at least one additional member vehicle to extend a vehicle temporary ID duration. In some aspects, receiver mobile station 410 may transmit the extension request based at least in part on an occurrence of an ID extension condition. For example, the ID extension condition may be related to a processing capability of the receiver mobile station 410 not satisfying a processing threshold condition. As shown by reference number 475, the transmitter mobile station 405 may extend a vehicle temporary ID duration, thereby delaying changing its vehicle temporary ID and, as a result, facilitating identification, by the receiver mobile station 410, of an association between a received PCM or BSM and a subsequently received PCM or BSM.

As indicated above, FIG. 4 is provided as an example. Other examples may differ from what is described with respect to FIG. 4.

As described above, mobile stations in a vehicle platoon may use a cooperative transmission scheme to transmit PCMs and BSMs. FIG. 5 is a diagram illustrating an example 500 of flexible platoon control messaging using a cooperative messaging scheme, in accordance with the present disclosure. As shown, a vehicle platoon 505 may include member vehicles V1, V2, and V3. The member vehicles V1, V2, and V3 may each include, be, or be similar to, the transmitter mobile station 405 shown in FIG. 4, the receiver mobile station 410 shown in FIG. 4, and/or the lead vehicle 415 shown in FIG. 4.

As shown by reference number 510, the lead vehicle, V1, may transmit a platoon configuration to the other member vehicles V2 and V3. The platoon configuration may indicate a set 515 of PCMs and/or a message flow configuration 520, among other examples. For example, in some aspects, the platoon configuration may indicate vehicle temporary ID extension rules, ID change conditions, transmission power control information, vehicle data reporting configurations, and/or messaging protocol configurations, among other examples.

In some aspects, for example, the set 515 of PCMs may include a number of different PCMs having different PCM structures. In the illustrated example 500, the set 515 of PCMs may include four different PCMs. For example, as shown, a first PCM (shown as “PCM A”) may include a set of basic data elements (shown as “Basic data”), a set of motion data elements (shown as “Motion data”), a set of vehicle dynamic data elements (shown as “Vehicle dynamic data”), a set of platoon vehicle state data elements (shown as “Platoon vehicle state data”), and a set of platoon control data elements (shown as “Platoon control data”). A second PCM (shown as “PCM B”) may include a set of basic data elements, a set of platoon vehicle state data elements, and a set of platoon control data elements. A third PCM (shown as “PCM C”) may include a set of basic data elements, a set of motion data elements, a set of vehicle dynamic data elements, and a set of platoon vehicle state data elements. A fourth PCM (shown as “PCM D”) may include a set of basic data elements and a set of platoon vehicle state data elements. According to some aspects, any number of different configurations of PCM structures and/or numbers of PCMs may be used to facilitate a cooperative transmission scheme.

As shown, the message flow configuration 520 may indicate a sequence of messages to be transmitted by each of the member vehicles V1, V2, and V3. Message start times (transmission times) may be different for each of the vehicles V1, V2, and V3 to reduce the possibility of intra-platoon interference. As shown, the lead vehicle V1 may be configured to transmit a sequence of messages by transmitting a first BSM, transmitting a PCM B after transmitting the first BSM, transmitting a PCM A after transmitting the PCM B, and transmitting a second BSM after transmitting the PCM A. As shown, the sequence may be configured to repeat. The vehicle V2 and the vehicle V3 may be configured to transmit a first BSM, a PCM D after the first BSM, a PCM C after the PCM D, and a second BSM after the PCM D. In some aspects, the configuration may indicate a configured BSM transmission time (or relative time) associated with a neighboring free vehicle (shown as V4). A free vehicle is a vehicle that is not part of the vehicle platoon 505, and may be configured to transmit BSMs according to a BSM configuration. In some aspects, the message flow configuration 520 may not indicate the free vehicle BSM transmission sequence.

In some aspects, PCMs may associated with certain member vehicles based at least in part on the respective positions of the vehicles within the vehicle platoon. For example, in some aspects, a PCM transmitted by a member vehicle may include a particular set of data elements based at least in part on the member vehicle being the lead vehicle. Similarly, in some aspects, a PCM transmitted by a member vehicle may include a different set of data elements based at least in part on the member vehicle being a following vehicle.

As indicated above, FIG. 5 is provided as an example. Other examples may differ from what is described with respect to FIG. 5.

FIG. 6 is a diagram illustrating an example process 600 performed, for example, by a transmitter mobile station associated with a member vehicle of a vehicle platoon, in accordance with the present disclosure. Example process 600 is an example where the transmitter mobile station (e.g., transmitter mobile station 405) performs operations associated with flexible platoon control messaging.

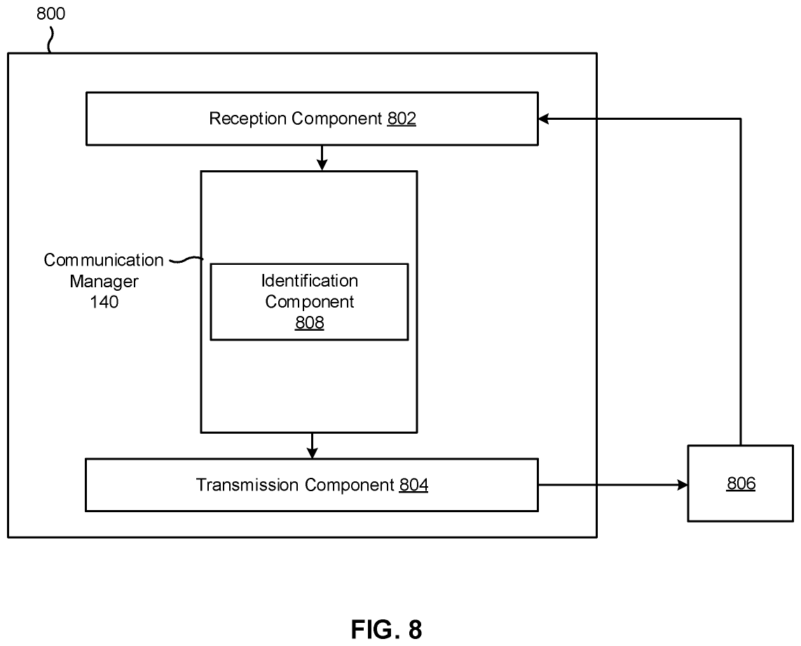

As shown in FIG. 6, in some aspects, process 600 may include transmitting at least one PCM having a flexible structure, the at least one PCM comprising a first part and a second part that is different from the first part, wherein the first part comprises non-platoon-specific data elements and the second part comprises platoon-specific data elements (block 610). For example, the transmitter mobile station (e.g., using communication manager 140 and/or transmission component 804, depicted in FIG. 8) may transmit at least one PCM having a flexible structure, the at least one PCM comprising a first part and a second part that is different from the first part, wherein the first part comprises non-platoon-specific data elements and the second part comprises platoon-specific data elements, as described above.

As further shown in FIG. 6, in some aspects, process 600 may include transmitting at least one BSM (block 620). For example, the transmitter mobile station (e.g., using communication manager 140 and/or transmission component 804, depicted in FIG. 8) may transmit at least one BSM, as described above.

Process 600 may include additional aspects, such as any single aspect or any combination of aspects described below and/or in connection with one or more other processes described elsewhere herein.

In a first aspect, the non-platoon-specific data elements comprise at least one of a set of basic data elements, a set of motion data elements associated with the member vehicle, or a set of vehicle dynamic data elements associated with the member vehicle.

In a second aspect, alone or in combination with the first aspect, the set of basic data elements indicates at least one of a timestamp associated with the at least one PCM, a message count associated with the at least one PCM, a vehicle temporary ID associated with the member vehicle, or a platoon ID associated with the vehicle platoon.

In a third aspect, alone or in combination with one or more of the first and second aspects, the set of motion data elements indicates at least one of a position of the member vehicle, a heading of the member vehicle, a velocity of the member vehicle, or an acceleration of the member vehicle.

In a fourth aspect, alone or in combination with the third aspect, the non-platoon-specific data elements further comprise an accuracy level associated with one or more data elements of the set of motion data elements.

In a fifth aspect, alone or in combination with one or more of the first through fourth aspects, the set of vehicle dynamic data elements indicates at least one of a brake status associated with the member vehicle, a light status associated with the member vehicle, a throttle status associated with the member vehicle, or a steering status associated with the member vehicle.

In a sixth aspect, alone or in combination with one or more of the first through fifth aspects, transmitting the at least one PCM comprises transmitting a sequence of PCMs comprising a first PCM that comprises a first instance of the set of motion data elements and a first instance of the set of vehicle dynamic data elements, and a second consecutive PCM that does not comprise an instance of the set of motion data elements and does not comprise an instance of the set of vehicle dynamic data elements.

In a seventh aspect, alone or in combination with the sixth aspect, process 600 includes transmitting, by the transmitter mobile station, a third consecutive PCM that comprises a second instance of the set of motion data elements and a second instance of the set of vehicle dynamic data elements.

In an eighth aspect, alone or in combination with one or more of the sixth through seventh aspects, process 600 includes transmitting, by the transmitter mobile station, a single BSM of the at least one BSM, wherein the single BSM comprises a second instance of the set of motion data elements and a second instance of the set of vehicle dynamic data elements.

In a ninth aspect, alone or in combination with one or more of the first through eighth aspects, the first PCM comprises the set of basic data elements, and the second consecutive PCM comprises the set of basic data elements.

In a tenth aspect, alone or in combination with one or more of the first through ninth aspects, the platoon-specific data elements comprise at least one of a set of platoon vehicle state data elements associated with the member vehicle, or a set of platoon control data elements.

In an eleventh aspect, alone or in combination with the tenth aspect, the set of platoon vehicle state data elements associated with the member vehicle indicate at least one of a vehicle member identifier associated with the member vehicle, a distance between the member vehicle and an adjacent vehicle of the at least one additional member vehicle, or a relative platoon position of the member vehicle with respect to the at least one additional member vehicle.

In a twelfth aspect, alone or in combination with one or more of the tenth through eleventh aspects, the set of platoon control data elements indicate at least one of a target time gap associated with the vehicle platoon, a target clearance associated with the vehicle platoon, a target acceleration associated with the vehicle platoon, a target curvature associated with the vehicle platoon, a target behavior associated with the vehicle platoon, or a target trajectory associated with the vehicle platoon.

In a thirteenth aspect, alone or in combination with one or more of the tenth through twelfth aspects, process 600 includes receiving, by the transmitter mobile station, at least a portion of the set of platoon control data elements from a lead platoon vehicle.

In a fourteenth aspect, alone or in combination with one or more of the first through thirteenth aspects, at least one data element of the first part of the PCM is identical to at least one data element of the BSM.

In a fifteenth aspect, alone or in combination with one or more of the first through fourteenth aspects, transmitting the at least one PCM comprises transmitting the at least one PCM using a cooperative transmission scheme to transmit the at least one PCM and the at least one BSM.

In a sixteenth aspect, alone or in combination with one or more of the first through fifteenth aspects, transmitting the at least one PCM comprises transmitting the at least one PCM using a first transmission frequency, and transmitting the at least one BSM comprises transmitting the at least one BSM using a second transmission frequency that is different than the first transmission frequency.

In a seventeenth aspect, alone or in combination with the sixteenth aspect, the first transmission frequency is higher than the second transmission frequency.

In an eighteenth aspect, alone or in combination with one or more of the first through seventeenth aspects, transmitting the at least one PCM comprises transmitting at least one groupcast communication comprising the at least one PCM.

In a nineteenth aspect, alone or in combination with one or more of the first through eighteenth aspects, the at least one PCM comprises a vehicle temporary ID associated with the member vehicle, and the at least one BSM comprises the vehicle temporary ID.

In a twentieth aspect, alone or in combination with the nineteenth aspects, process 600 includes transmitting, by the transmitter mobile station, at least one additional BSM comprising an updated vehicle temporary ID associated with the member vehicle, and transmitting, by the transmitter mobile station, at least one additional PCM comprising the updated vehicle temporary ID based at least in part on transmitting the at least one additional BSM comprising the updated vehicle temporary ID.

In a twenty-first aspect, alone or in combination with the twentieth aspect, process 600 includes transmitting, by the transmitter mobile station to a lead vehicle of the vehicle platoon, a unicast communication comprising an ID change indication that indicates the updated vehicle temporary ID.

In a twenty-second aspect, alone or in combination with one or more of the twentieth through twenty-first aspects, process 600 includes transmitting, by the transmitter mobile station to the at least one additional member vehicle, a groupcast communication comprising an ID change indication that indicates the updated vehicle temporary ID.

In a twenty-third aspect, alone or in combination with one or more of the twentieth through twenty-second aspects, process 600 includes extending, by the transmitter mobile station, a vehicle temporary ID duration based at least in part on an occurrence of an ID extension condition.

In a twenty-fourth aspect, alone or in combination with the twenty-third aspect, the ID extension condition is associated with at least one of an acceleration of the member vehicle, a deceleration of the member vehicle, or a curvature of a road on which the member vehicle is traveling.

In a twenty-fifth aspect, alone or in combination with one or more of the twenty-third through twenty-fourth aspects, the ID extension condition is associated with an extension request from a following member vehicle.

In a twenty-sixth aspect, alone or in combination with one or more of the twenty-third through twenty-fifth aspects, process 600 includes receiving, by the transmitter mobile station from a lead vehicle of the vehicle platoon, an extension configuration that indicates the ID extension condition.

In a twenty-seventh aspect, alone or in combination with one or more of the first through twenty-sixth aspects, transmitting the at least one PCM and transmitting the at least one BSM comprises transmitting a sequence of messages comprising the at least one PCM and the at least one BSM.

In a twenty-eighth aspect, alone or in combination with the twenty-seventh aspect, transmitting the sequence of messages comprises transmitting a first BSM of the at least one BSM, transmitting the at least one PCM after transmitting the first BSM, and transmitting a second BSM of the at least one BSM after transmitting the at least one PCM.

In a twenty-ninth aspect, alone or in combination with the twenty-eighth aspect, the member vehicle is a lead vehicle of the vehicle platoon, and the at least one PCM comprises a specified set of data elements based at least in part on the member vehicle being the lead vehicle.

In a thirtieth aspect, alone or in combination with the twenty-eighth aspect, the member vehicle is a following vehicle of the vehicle platoon, and the at least one PCM comprises a specified set of data elements based at least in part on the member vehicle being the following vehicle.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a receiver mobile station associated with a member vehicle of a vehicle platoon, in accordance with the present disclosure. Example process 700 is an example where the receiver mobile station (e.g., receiver mobile station 410) performs operations associated with flexible platoon control messaging.

As shown in FIG. 7, in some aspects, process 700 may include receiving at least one PCM having a flexible structure, the at least one PCM comprising a first part and a second part that is different from the first part, wherein the first part comprises non-platoon-specific data elements and the second part comprises platoon-specific data elements (block 710). For example, the receiver mobile station (e.g., using communication manager 140 and/or reception component 802, depicted in FIG. 8) may receive at least one PCM having a flexible structure, the at least one PCM comprising a first part and a second part that is different from the first part, wherein the first part comprises non-platoon-specific data elements and the second part comprises platoon-specific data elements, as described above.

As further shown in FIG. 7, in some aspects, process 700 may include receiving at least one BSM (block 720). For example, the receiver mobile station (e.g., using communication manager 140 and/or reception component 802, depicted in FIG. 8) may receive at least one BSM, as described above.

Process 700 may include additional aspects, such as any single aspect or any combination of aspects described below and/or in connection with one or more other processes described elsewhere herein.

In a first aspect, the non-platoon-specific data elements comprise at least one of a set of basic data elements, a set of motion data elements associated with the at least one additional member vehicle, or a set of vehicle dynamic data elements associated with the at least one additional member vehicle.

In a second aspect, alone or in combination with the first aspect, the set of basic data elements indicates at least one of a timestamp associated with the at least one PCM, a message count associated with the at least one PCM, a vehicle temporary ID associated with the at least one additional member vehicle, or a platoon ID associated with the vehicle platoon.

In a third aspect, alone or in combination with one or more of the first and second aspects, the set of motion data elements indicates at least one of a position of the at least one additional member vehicle, a heading of the at least one additional member vehicle, a velocity of the at least one additional member vehicle, or an acceleration of the at least one additional member vehicle.

In a fourth aspect, alone or in combination with the third aspect, the non-platoon-specific data elements further comprise an accuracy level associated with one or more data elements of the set of motion data elements.

In a fifth aspect, alone or in combination with one or more of the first through fourth aspects, the set of vehicle dynamic data elements indicates at least one of a brake status associated with the at least one additional member vehicle, a light status associated with the at least one additional member vehicle, a throttle status associated with the at least one additional member vehicle, or a steering status associated with the at least one additional member vehicle.

In a sixth aspect, alone or in combination with one or more of the first through fifth aspects, receiving the at least one PCM comprises receiving a sequence of PCMs comprising a first PCM that comprises a first instance of the set of motion data elements and a first instance of the set of vehicle dynamic data elements, and a second consecutive PCM that does not comprise an instance of the set of motion data elements and that does not comprise an instance of the set of vehicle dynamic data elements.

In a seventh aspect, alone or in combination with the sixth aspect, process 700 includes receiving, by the receiver mobile station, a third consecutive PCM that comprises a second instance of the set of motion data elements and a second instance of the set of vehicle dynamic data elements.

In an eighth aspect, alone or in combination with one or more of the sixth through seventh aspects, process 700 includes receiving, by the receiver mobile station, a single BSM of the at least one BSM, wherein the single BSM comprises a second instance of the set of motion data elements and a second instance of the set of vehicle dynamic data elements.

In a ninth aspect, alone or in combination with one or more of the sixth through eighth aspects, the first PCM comprises the set of basic data elements, and the second consecutive PCM comprises the set of basic data elements.

In a tenth aspect, alone or in combination with one or more of the first through ninth aspects, the platoon-specific data elements comprise at least one of a set of platoon vehicle state data elements associated with the at least one additional member vehicle, or a set of platoon control data elements.

In an eleventh aspect, alone or in combination with the tenth aspect, the set of platoon vehicle state data elements associated with the at least one additional member vehicle indicate at least one of a vehicle member identifier associated with the at least one additional member vehicle, a distance between the member vehicle and an adjacent vehicle of the at least one additional member vehicle, or a relative platoon position of the member vehicle with respect to the at least one additional member vehicle.

In a twelfth aspect, alone or in combination with one or more of the tenth through eleventh aspects, the set of platoon control data elements indicate at least one of a target time gap associated with the vehicle platoon, a target clearance associated with the vehicle platoon, a target acceleration associated with the vehicle platoon, a target curvature associated with the vehicle platoon, a target behavior associated with the vehicle platoon, or a target trajectory associated with the vehicle platoon.

In a thirteenth aspect, alone or in combination with one or more of the tenth through twelfth aspects, process 700 includes receiving, by the receiver mobile station, at least a portion of the set of platoon control data elements from a lead platoon vehicle.

In a fourteenth aspect, alone or in combination with one or more of the first through thirteenth aspects, at least one data element of the first part of the PCM is identical to at least one data element of the BSM.

In a fifteenth aspect, alone or in combination with one or more of the first through fourteenth aspects, receiving the at least one PCM comprises receiving the at least one PCM using a cooperative transmission scheme to receive the at least one PCM and the at least one BSM.

In a sixteenth aspect, alone or in combination with one or more of the first through fifteenth aspects, receiving the at least one PCM comprises receiving the at least one PCM based at least in part on a first transmission frequency, and receiving the at least one BSM comprises receiving the at least one BSM based at least in part on a second transmission frequency that is different than the first transmission frequency.

In a seventeenth aspect, alone or in combination with the sixteenth aspect, the first transmission frequency is higher than the second transmission frequency.

In an eighteenth aspect, alone or in combination with one or more of the first through seventeenth aspects, receiving the at least one PCM comprises receiving at least one groupcast communication comprising the at least one PCM.

In a nineteenth aspect, alone or in combination with one or more of the first through eighteenth aspects, the at least one PCM comprises a vehicle temporary ID associated with the at least one additional member vehicle, and the at least one BSM comprises the vehicle temporary ID.

In a twentieth aspect, alone or in combination with the nineteenth aspect, process 700 includes receiving, by the receiver mobile station, at least one additional BSM comprising an updated vehicle temporary ID associated with the at least one additional member vehicle, and receiving, by the receiver mobile station, at least one additional PCM comprising the updated vehicle temporary ID based.

In a twenty-first aspect, alone or in combination with the twentieth aspect, process 700 includes identifying, by the receiver mobile station, an association between the at least one additional BSM and the at least one PCM based at least in part on motion state tracking information.

In a twenty-second aspect, alone or in combination with the twenty-first aspect, the at least one additional BSM comprises motion data elements associated with the at least one additional member vehicle, and the motion state tracking information comprises a predicted position value based at least in part on the motion data elements.

In a twenty-third aspect, alone or in combination with the twenty-second aspect, the at least one PCM comprises a prior position value, and identifying the association comprises identifying the association based at least in part on a difference between the predicted position value and a subsequent position value satisfying an uncertainty condition.

In a twenty-fourth aspect, alone or in combination with one or more of the twenty-first through twenty-third aspects, process 700 includes receiving, by the receiver mobile station, an indication of a size of the vehicle platoon, receiving, by the receiver mobile station, an indication of a position of a lead vehicle of the vehicle platoon, and identifying, by the receiver mobile station, a member vehicle of the at least one additional member vehicle that corresponds to a closest predicted position, of a plurality of predicted positions, to a position value indicated by the at least one additional BSM.

In a twenty-fifth aspect, alone or in combination with one or more of the twenty-first through twenty-fourth aspects, the motion state tracking information comprises an indication of a lane index associated with the vehicle platoon.

In a twenty-sixth aspect, alone or in combination with one or more of the twentieth through twenty-fifth aspects, process 700 includes receiving, by the receiver mobile station from the at least one additional member vehicle, a groupcast communication comprising an ID change indication that indicates the updated vehicle temporary ID.

In a twenty-seventh aspect, alone or in combination with one or more of the nineteenth through twenty-sixth aspects, process 700 includes transmitting, by the receiver mobile station, an extension request for the at least one additional vehicle to extend a vehicle temporary ID duration.

In a twenty-eighth aspect, alone or in combination with the twenty-seventh aspect, transmitting the extension request comprises transmitting the extension request based at least in part on an occurrence of an ID extension condition.

In a twenty-ninth aspect, alone or in combination with the twenty-eighth aspect, the ID extension condition is related to a processing capability of the receiver mobile station not satisfying a processing threshold condition.

In a thirtieth aspect, alone or in combination with one or more of the twenty-eighth through twenty-ninth aspects, process 700 includes receiving, by the receiver mobile station from a lead vehicle of the vehicle platoon, an extension configuration that indicates the ID extension condition.

In a thirty-first aspect, alone or in combination with one or more of the first through thirtieth aspects, receiving the at least one PCM and receiving the at least one BSM comprises receiving a sequence of messages comprising the at least one PCM and the at least one BSM.

In a thirty-second aspect, alone or in combination with the thirty-first aspect, receiving the sequence of messages comprises receiving a first BSM of the at least one BSM, receiving the at least one PCM after receiving the first BSM, and receiving a second BSM of the at least one BSM after receiving the at least one PCM.

In a thirty-third aspect, alone or in combination with the thirty-second aspect, the at least one additional member vehicle is a lead vehicle of the vehicle platoon, and the at least one PCM comprises a specified set of data elements based at least in part on the at least one additional member vehicle being the lead vehicle.

In a thirty-fourth aspect, alone or in combination with the thirty-second aspect, the at least one additional member vehicle is a following vehicle of the vehicle platoon, and the at least one PCM comprises a specified set of data elements based at least in part on the at least one additional member vehicle being the following vehicle.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a mobile station (e.g., a transmitter mobile station or a receiver mobile station), or a mobile station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include an identification component 808.

In some aspects, the apparatus 800 may be configured to perform one or more operations described herein in connection with FIGS. 4 and 5. Additionally, or alternatively, the apparatus 800 may be configured to perform one or more processes described herein, such as process 600 of FIG. 6, process 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The transmission component 804 may transmit at least one PCM having a flexible structure, the at least one PCM comprising a first part and a second part that is different from the first part, wherein the first part comprises non-platoon-specific data elements and the second part comprises platoon-specific data elements. The transmission component 804 may transmit at least one BSM.

The transmission component 804 may transmit a third consecutive PCM that comprises a second instance of the set of motion data elements and a second instance of the set of vehicle dynamic data elements. The transmission component 804 may transmit a single BSM of the at least one BSM, wherein the single BSM comprises a second instance of the set of motion data elements and a second instance of the set of vehicle dynamic data elements. The reception component 802 may receive at least a portion of the set of platoon control data elements from a lead platoon vehicle.

The transmission component 804 may transmit at least one additional BSM comprising an updated vehicle temporary ID associated with the member vehicle. The transmission component 804 may transmit at least one additional PCM comprising the updated vehicle temporary ID based at least in part on transmitting the at least one additional BSM comprising the updated vehicle temporary ID.

The transmission component 804 may transmit a unicast communication comprising an ID change indication that indicates the updated vehicle temporary ID. The transmission component 804 may transmit a groupcast communication comprising an ID change indication that indicates the updated vehicle temporary ID.

The communication manager 140 may extend a vehicle temporary ID duration based at least in part on an occurrence of an ID extension condition. The reception component 802 may receive an extension configuration that indicates the ID extension condition. In some aspects, the communication manager 140 may include one or more antennas, a modem, a modulator, a transmit MIMO processor, a transmit processor, a controller/processor, a memory, or a combination thereof, of the UE described in connection with FIG. 2. In some aspects, the communication manager 140 may include the reception component 802 and/or the transmission component 804.

The reception component 802 may receive at least one PCM having a flexible structure, the at least one PCM comprising a first part and a second part that is different from the first part, wherein the first part comprises non-platoon-specific data elements and the second part comprises platoon-specific data elements. The reception component 802 may receive at least one BSM. The reception component 802 may receive a third consecutive PCM that comprises a second instance of the set of motion data elements and a second instance of the set of vehicle dynamic data elements. The reception component 802 may receive a single BSM of the at least one BSM, wherein the single BSM comprises a second instance of the set of motion data elements and a second instance of the set of vehicle dynamic data elements.

The reception component 802 may receive at least a portion of the set of platoon control data elements from a lead platoon vehicle. The reception component 802 may receive at least one additional BSM comprising an updated vehicle temporary ID associated with the at least one additional member vehicle. The reception component 802 may receive at least one additional PCM comprising the updated vehicle temporary ID based.

The identification component 808 may identify an association between the at least one additional BSM and the at least one PCM based at least in part on motion state tracking information. In some aspects, the identification component 808 may include one or more antennas, a modem, a modulator, a transmit MIMO processor, a transmit processor, a controller/processor, a memory, or a combination thereof, of the UE described in connection with FIG. 2. In some aspects, the identification component 808 may include the reception component 802 and/or the transmission component 804.

The reception component 802 may receive an indication of a size of the vehicle platoon. The reception component 802 may receive an indication of a position of a lead vehicle of the vehicle platoon. The identification component 808 may identify a member vehicle of the at least one additional member vehicle that corresponds to a closest predicted position, of a plurality of predicted positions, to a position value indicated by the at least one additional BSM.

The reception component 802 may receive a groupcast communication comprising an ID change indication that indicates the updated vehicle temporary ID. The transmission component 804 may transmit an extension request for the at least one additional vehicle to extend a vehicle temporary ID duration. The reception component 802 may receive an extension configuration that indicates the ID extension condition.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a transmitter mobile station associated with a member vehicle of a vehicle platoon, comprising: transmitting, by the transmitter mobile station to at least one additional member vehicle of the vehicle platoon, at least one platoon control message (PCM) having a flexible structure, the at least one PCM comprising a first part and a second part that is different from the first part, wherein the first part comprises non-platoon-specific data elements and the second part comprises platoon-specific data elements; and transmitting, by the transmitter mobile station, at least one basic safety message (BSM).

Aspect 2: The method of Aspect 1, wherein the non-platoon-specific data elements comprise at least one of: a set of basic data elements, a set of motion data elements associated with the member vehicle, or a set of vehicle dynamic data elements associated with the member vehicle.

Aspect 3: The method of Aspect 2, wherein the set of basic data elements indicates at least one of: a timestamp associated with the at least one PCM, a message count associated with the at least one PCM, a vehicle temporary identifier (ID) associated with the member vehicle, or a platoon ID associated with the vehicle platoon.

Aspect 4: The method of either of Aspects 2 or 3, wherein the set of motion data elements indicates at least one of: a position of the member vehicle, a heading of the member vehicle, a velocity of the member vehicle, or an acceleration of the member vehicle.

Aspect 5: The method of Aspect 4, wherein the non-platoon-specific data elements further comprise an accuracy level associated with one or more data elements of the set of motion data elements.

Aspect 6: The method of any of Aspects 2-5, wherein the set of vehicle dynamic data elements indicates at least one of: a brake status associated with the member vehicle, a light status associated with the member vehicle, a throttle status associated with the member vehicle, or a steering status associated with the member vehicle.

Aspect 7: The method of any of Aspects 2-6, wherein transmitting the at least one PCM comprises transmitting a sequence of PCMs comprising: a first PCM that comprises a first instance of the set of motion data elements and a first instance of the set of vehicle dynamic data elements; and a second consecutive PCM that does not comprise an instance of the set of motion data elements and does not comprise an instance of the set of vehicle dynamic data elements.

Aspect 8: The method of Aspect 7, further comprising transmitting, by the transmitter mobile station, a third consecutive PCM that comprises a second instance of the set of motion data elements and a second instance of the set of vehicle dynamic data elements.

Aspect 9: The method of either of Aspects 7 or 8, further comprising transmitting, by the transmitter mobile station, a single BSM of the at least one BSM, wherein the single BSM comprises a second instance of the set of motion data elements and a second instance of the set of vehicle dynamic data elements.

Aspect 10: The method of any of Aspects 2-9, wherein the first PCM comprises the set of basic data elements, and the second consecutive PCM comprises the set of basic data elements.

Aspect 11: The method of any of Aspects 1-10, wherein the platoon-specific data elements comprise at least one of: a set of platoon vehicle state data elements associated with the member vehicle, or a set of platoon control data elements.

Aspect 12: The method of Aspect 11, wherein the set of platoon vehicle state data elements associated with the member vehicle indicate at least one of: a vehicle member identifier associated with the member vehicle, a distance between the member vehicle and an adjacent vehicle of the at least one additional member vehicle, or a relative platoon position of the member vehicle with respect to the at least one additional member vehicle.

Aspect 13: The method of either of Aspects 11 or 12, wherein the set of platoon control data elements indicate at least one of: a target time gap associated with the vehicle platoon, a target clearance associated with the vehicle platoon, a target acceleration associated with the vehicle platoon, a target curvature associated with the vehicle platoon, a target behavior associated with the vehicle platoon, or a target trajectory associated with the vehicle platoon.

Aspect 14: The method of any of Aspects 11-13, further comprising receiving, by the transmitter mobile station, at least a portion of the set of platoon control data elements from a lead platoon vehicle.

Aspect 15: The method of any of Aspects 1-14, wherein at least one data element of the first part of the PCM is identical to at least one data element of the BSM.

Aspect 16: The method of any of Aspects 1-15, wherein transmitting the at least one PCM comprises transmitting the at least one PCM using a cooperative transmission scheme to transmit the at least one PCM and the at least one BSM.

Aspect 17: The method of any of Aspects 1-16, wherein transmitting the at least one PCM comprises transmitting the at least one PCM using a first transmission frequency, and wherein transmitting the at least one BSM comprises transmitting the at least one BSM using a second transmission frequency that is different than the first transmission frequency.

Aspect 18: The method of Aspect 17, wherein the first transmission frequency is higher than the second transmission frequency.

Aspect 19: The method of any of Aspects 1-18, wherein transmitting the at least one PCM comprises transmitting at least one groupcast communication comprising the at least one PCM.

Aspect 20: The method of any of Aspects 1-19, wherein the at least one PCM comprises a vehicle temporary identifier (ID) associated with the member vehicle, and wherein the at least one BSM comprises the vehicle temporary ID.

Aspect 21: The method of Aspect 20, further comprising: transmitting, by the transmitter mobile station, at least one additional BSM comprising an updated vehicle temporary ID associated with the member vehicle, and transmitting, by the transmitter mobile station, at least one additional PCM comprising the updated vehicle temporary ID based at least in part on transmitting the at least one additional BSM comprising the

Aspect 22: The method of Aspect 21, further comprising transmitting, by the transmitter mobile station to a lead vehicle of the vehicle platoon, a unicast communication comprising an ID change indication that indicates the updated vehicle temporary ID.

Aspect 23: The method of either of Aspects 21 or 22, further comprising transmitting, by the transmitter mobile station to the at least one additional member vehicle, a groupcast communication comprising an ID change indication that indicates the updated vehicle temporary ID.

Aspect 24: The method of any of Aspects 21-23, further comprising extending, by the transmitter mobile station, a vehicle temporary ID duration based at least in part on an occurrence of an ID extension condition.

Aspect 25: The method of Aspect 24, wherein the ID extension condition is associated with at least one of an acceleration of the member vehicle, a deceleration of the member vehicle, or a curvature of a road on which the member vehicle is traveling.

Aspect 26: The method of either of Aspects 24 or 25, wherein the ID extension condition is associated with an extension request from a following member vehicle.

Aspect 27: The method of any of Aspects 24-26, further comprising receiving, by the transmitter mobile station from a lead vehicle of the vehicle platoon, an extension configuration that indicates the ID extension condition.

Aspect 28: The method of any of Aspects 1-27, wherein transmitting the at least one PCM and transmitting the at least one BSM comprises transmitting a sequence of messages comprising the at least one PCM and the at least one BSM.

Aspect 29: The method of Aspect 28, wherein transmitting the sequence of messages comprises: transmitting a first BSM of the at least one BSM; transmitting the at least one PCM after transmitting the first BSM; and transmitting a second BSM of the at least one BSM after transmitting the at least one PCM.

Aspect 30: The method of Aspect 29, wherein the member vehicle is a lead vehicle of the vehicle platoon, and wherein the at least one PCM comprises a specified set of data elements based at least in part on the member vehicle being the lead vehicle.

Aspect 31: The method of Aspect 29, wherein the member vehicle is a following vehicle of the vehicle platoon, and wherein the at least one PCM comprises a specified set of data elements based at least in part on the member vehicle being the following vehicle.

Aspect 32: A method of wireless communication performed by a receiver mobile station associated with a member vehicle of a vehicle platoon, comprising: receiving, by the receiver mobile station from at least one additional member vehicle of the vehicle platoon, at least one platoon control message (PCM) having a flexible structure, the at least one PCM comprising a first part and a second part that is different from the first part, wherein the first part comprises non-platoon-specific data elements and the second part comprises platoon-specific data elements; and receiving, by the receiver mobile station from the at least one additional member vehicle of the vehicle platoon, at least one basic safety message (BSM).

Aspect 33: The method of Aspect 32, wherein the non-platoon-specific data elements comprise at least one of: a set of basic data elements, a set of motion data elements associated with the at least one additional member vehicle, or a set of vehicle dynamic data elements associated with the at least one additional member vehicle.

Aspect 34: The method of Aspect 33, wherein the set of basic data elements indicates at least one of: a timestamp associated with the at least one PCM, a message count associated with the at least one PCM, a vehicle temporary identifier (ID) associated with the at least one additional member vehicle, or a platoon ID associated with the vehicle platoon.

Aspect 35: The method of either of Aspects 33 or 34, wherein the set of motion data elements indicates at least one of: a position of the at least one additional member vehicle, a heading of the at least one additional member vehicle, a velocity of the at least one additional member vehicle, or an acceleration of the at least one additional member vehicle.

Aspect 36: The method of Aspect 35, wherein the non-platoon-specific data elements further comprise an accuracy level associated with one or more data elements of the set of motion data elements.

Aspect 37: The method of any of Aspects 33-36, wherein the set of vehicle dynamic data elements indicates at least one of: a brake status associated with the at least one additional member vehicle, a light status associated with the at least one additional member vehicle, a throttle status associated with the at least one additional member vehicle, or a steering status associated with the at least one additional member vehicle.

Aspect 38: The method of any of Aspects 33-37, wherein receiving the at least one PCM comprises receiving a sequence of PCMs comprising: a first PCM that comprises a first instance of the set of motion data elements and a first instance of the set of vehicle dynamic data elements; and a second consecutive PCM that does not comprise an instance of the set of motion data elements and that does not comprise an instance of the set of vehicle dynamic data elements.

Aspect 39: The method of Aspect 38, further comprising receiving, by the receiver mobile station, a third consecutive PCM that comprises a second instance of the set of motion data elements and a second instance of the set of vehicle dynamic data elements.

Aspect 40: The method of either of Aspects 38 or 39, further comprising receiving, by the receiver mobile station, a single BSM of the at least one BSM, wherein the single BSM comprises a second instance of the set of motion data elements and a second instance of the set of vehicle dynamic data elements.

Aspect 41: The method of any of Aspects 38-40, wherein the first PCM comprises the set of basic data elements, and the second consecutive PCM comprises the set of basic data elements.

Aspect 42: The method of any of Aspects 32-41, wherein the platoon-specific data elements comprise at least one of: a set of platoon vehicle state data elements associated with the at least one additional member vehicle, or a set of platoon control data elements.

Aspect 43: The method of Aspect 42, wherein the set of platoon vehicle state data elements associated with the at least one additional member vehicle indicate at least one of: a vehicle member identifier associated with the at least one additional member vehicle, a distance between the member vehicle and an adjacent vehicle of the at least one additional member vehicle, or a relative platoon position of the member vehicle with respect to the at least one additional member vehicle.

Aspect 44: The method of either of Aspects 42 or 43, wherein the set of platoon control data elements indicate at least one of: a target time gap associated with the vehicle platoon, a target clearance associated with the vehicle platoon, a target acceleration associated with the vehicle platoon, a target curvature associated with the vehicle platoon, a target behavior associated with the vehicle platoon, or a target trajectory associated with the vehicle platoon.

Aspect 45: The method of any of Aspects 42-44, further comprising receiving, by the receiver mobile station, at least a portion of the set of platoon control data elements from a lead platoon vehicle.

Aspect 46: The method of any of Aspects 32-45, wherein at least one data element of the first part of the PCM is identical to at least one data element of the BSM.

Aspect 47: The method of any of Aspects 32-46, wherein receiving the at least one PCM comprises receiving the at least one PCM using a cooperative transmission scheme to receive the at least one PCM and the at least one BSM.

Aspect 48: The method of any of Aspects 32-47, wherein receiving the at least one PCM comprises receiving the at least one PCM based at least in part on a first transmission frequency, and wherein receiving the at least one BSM comprises receiving the at least one BSM based at least in part on a second transmission frequency that is different than the first transmission frequency.

Aspect 49: The method of Aspect 48, wherein the first transmission frequency is higher than the second transmission frequency.

Aspect 50: The method of any of Aspects 32-49, wherein receiving the at least one PCM comprises receiving at least one groupcast communication comprising the at least one PCM.

Aspect 51: The method of any of Aspects 32-50, wherein the at least one PCM comprises a vehicle temporary identifier (ID) associated with the at least one additional member vehicle, and wherein the at least one BSM comprises the vehicle temporary ID.

Aspect 52: The method of Aspect 51, further comprising: receiving, by the receiver mobile station, at least one additional BSM comprising an updated vehicle temporary ID associated with the at least one additional member vehicle, and receiving, by the receiver mobile station, at least one additional PCM comprising the updated vehicle temporary ID based.

Aspect 53: The method of Aspect 52, further comprising identifying, by the receiver mobile station, an association between the at least one additional BSM and the at least one PCM based at least in part on motion state tracking information.

Aspect 54: The method of Aspect 53, wherein the at least one additional BSM comprises motion data elements associated with the at least one additional member vehicle, and wherein the motion state tracking information comprises a predicted position value based at least in part on the motion data elements.

Aspect 55: The method of Aspect 54, wherein the at least one PCM comprises a prior position value, and wherein identifying the association comprises identifying the association based at least in part on a difference between the predicted position value and a subsequent position value satisfying an uncertainty condition.

Aspect 56: The method of any of Aspects 53-55, further comprising: receiving, by the receiver mobile station, an indication of a size of the vehicle platoon; receiving, by the receiver mobile station, an indication of a position of a lead vehicle of the vehicle platoon; and identifying, by the receiver mobile station, a member vehicle of the at least one additional member vehicle that corresponds to a closest predicted position, of a plurality of predicted positions, to a position value indicated by the at least one additional BSM.

Aspect 57: The method of any of Aspects 53-56, wherein the motion state tracking information comprises an indication of a lane index associated with the vehicle platoon.

Aspect 58: The method of any of Aspects 52-57, further comprising receiving, by the receiver mobile station from the at least one additional member vehicle, a groupcast communication comprising an ID change indication that indicates the updated vehicle temporary ID.

Aspect 59: The method of any of Aspects 51-58, further comprising transmitting, by the receiver mobile station, an extension request for the at least one additional vehicle to extend a vehicle temporary ID duration.

Aspect 60: The method of Aspect 59, wherein transmitting the extension request comprises transmitting the extension request based at least in part on an occurrence of an ID extension condition.

Aspect 61: The method of Aspect 60, wherein the ID extension condition is related to a processing capability of the receiver mobile station not satisfying a processing threshold condition.

Aspect 62: The method of either of Aspects 60 or 61, further comprising receiving, by the receiver mobile station from a lead vehicle of the vehicle platoon, an extension configuration that indicates the ID extension condition.

Aspect 63: The method of any of Aspects 32-62, wherein receiving the at least one PCM and receiving the at least one BSM comprises receiving a sequence of messages comprising the at least one PCM and the at least one BSM.

Aspect 64: The method of Aspect 63, wherein receiving the sequence of messages comprises: receiving a first BSM of the at least one BSM; receiving the at least one PCM after receiving the first BSM; and receiving a second BSM of the at least one BSM after receiving the at least one PCM.

Aspect 65: The method of Aspect 64, wherein the at least one additional member vehicle is a lead vehicle of the vehicle platoon, and wherein the at least one PCM comprises a specified set of data elements based at least in part on the at least one additional member vehicle being the lead vehicle.

Aspect 66: The method of Aspect 64, wherein the at least one additional member vehicle is a following vehicle of the vehicle platoon, and wherein the at least one PCM comprises a specified set of data elements based at least in part on the at least one additional member vehicle being the following vehicle.

Aspect 67: An apparatus for wireless communication at a device, comprising a processor; memory coupled with the processor; and instructions stored in the memory and executable by the processor to cause the apparatus to perform the method of one or more of Aspects 1-31.

Aspect 68: A device for wireless communication, comprising a memory and one or more processors coupled to the memory, the one or more processors configured to perform the method of one or more of Aspects 1-31.

Aspect 69: An apparatus for wireless communication, comprising at least one means for performing the method of one or more of Aspects 1-31.

Aspect 70: A non-transitory computer-readable medium storing code for wireless communication, the code comprising instructions executable by a processor to perform the method of one or more of Aspects 1-31.

Aspect 71: A non-transitory computer-readable medium storing a set of

instructions for wireless communication, the set of instructions comprising one or more instructions that, when executed by one or more processors of a device, cause the device to perform the method of one or more of Aspects 1-31.

Aspect 72: An apparatus for wireless communication at a device, comprising a processor; memory coupled with the processor; and instructions stored in the memory and executable by the processor to cause the apparatus to perform the method of one or more of Aspects 32-66.

Aspect 73: A device for wireless communication, comprising a memory and one or more processors coupled to the memory, the one or more processors configured to perform the method of one or more of Aspects 32-66.

Aspect 74: An apparatus for wireless communication, comprising at least one means for performing the method of one or more of Aspects 32-66.

Aspect 75: A non-transitory computer-readable medium storing code for wireless communication, the code comprising instructions executable by a processor to perform the method of one or more of Aspects 32-66.

Aspect 76: A non-transitory computer-readable medium storing a set of instructions for wireless communication, the set of instructions comprising one or more instructions that, when executed by one or more processors of a device, cause the device to perform the method of one or more of Aspects 32-66.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of”' a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitter mobile station associated with a member vehicle of a vehicle platoon, comprising:
a memory; and
one or more processors, coupled to the memory, configured to, based in part on information stored in the memory:
transmit at least one platoon control message (PCM) having a flexible structure, the at least one PCM comprising a first part and a second part that is different from the first part, wherein the first part comprises non-platoon-specific data elements and the second part comprises platoon-specific data elements; and
transmit at least one basic safety message (BSM).

2. The transmitter mobile station of claim 1, wherein the non-platoon-specific data elements comprise at least one of:
a set of basic data elements,
a set of motion data elements associated with the member vehicle, or
a set of vehicle dynamic data elements associated with the member vehicle.

3. The transmitter mobile station of claim 2, wherein the one or more processors, to transmit the at least one PCM, are configured to transmit a sequence of PCMs comprising:
a first PCM that comprises a first instance of the set of motion data elements and a first instance of the set of vehicle dynamic data elements; and
a second consecutive PCM that does not comprise an instance of the set of motion data elements and does not comprise an instance of the set of vehicle dynamic data elements.

4. The transmitter mobile station of claim 3, wherein the one or more processors are further configured to transmit a single BSM of the at least one BSM, wherein the single BSM comprises a second instance of the set of motion data elements and a second instance of the set of vehicle dynamic data elements.

5. The transmitter mobile station of claim 3, wherein the first PCM comprises the set of basic data elements, and the second consecutive PCM comprises the set of basic data elements.

6. The transmitter mobile station of claim 1, wherein the platoon-specific data elements comprise at least one of:
a set of platoon vehicle state data elements associated with the member vehicle, or
a set of platoon control data elements.

7. The transmitter mobile station of claim 1, wherein at least one data element of the first part of the PCM is identical to at least one data element of the BSM, and wherein the one or more processors, to transmit the at least one PCM, are configured to transmit the at least one PCM using a cooperative transmission scheme to transmit the at least one PCM and the at least one BSM.

8. The transmitter mobile station of claim 1, wherein the one or more processors, to transmit the at least one PCM, are configured to transmit the at least one PCM using a first transmission frequency, and wherein the one or more processors, to transmit the at least one BSM, are configured to transmit the at least one BSM using a second transmission frequency that is different than the first transmission frequency.

9. The transmitter mobile station of claim 1, wherein the at least one PCM comprises a vehicle temporary identifier (ID) associated with the member vehicle, and wherein the at least one BSM comprises the vehicle temporary ID.

10. The transmitter mobile station of claim 9, wherein the one or more processors are further configured to:
transmit at least one additional BSM comprising an updated vehicle temporary ID associated with the member vehicle; and
transmit at least one additional PCM comprising the updated vehicle temporary ID based at least in part on transmitting the at least one additional BSM comprising the

11. The transmitter mobile station of claim 10, wherein the one or more processors are further configured to transmit a unicast communication comprising an ID change indication that indicates the updated vehicle temporary ID.

12. The transmitter mobile station of claim 10, wherein the one or more processors are further configured to transmit a groupcast communication comprising an ID change indication that indicates the updated vehicle temporary ID.

13. The transmitter mobile station of claim 10, wherein the one or more processors are further configured to extend a vehicle temporary ID duration based at least in part on an occurrence of an ID extension condition.

14. The transmitter mobile station of claim 13, wherein the ID extension condition is associated with at least one of an acceleration of the member vehicle, a deceleration of the member vehicle, or a curvature of a road on which the member vehicle is traveling.

15. The transmitter mobile station of claim 13, wherein the one or more processors are further configured to receive an extension configuration that indicates the ID extension condition.

16. The transmitter mobile station of claim 1, wherein the one or more processors, to transmit the at least one PCM and the at least one BSM, are configured to transmit a sequence of messages comprising the at least one PCM and the at least one BSM.

17. The transmitter mobile station of claim 16, wherein the member vehicle is a lead vehicle of the vehicle platoon, and wherein the at least one PCM comprises a specified set of data elements based at least in part on the member vehicle being the lead vehicle.

18. A receiver mobile station associated with a member vehicle of a vehicle platoon, comprising:
a memory; and
one or more processors, coupled to the memory, configured to, based in part on information stored in the memory:
receive at least one platoon control message (PCM) having a flexible structure, the at least one PCM comprising a first part and a second part that is different from the first part, wherein the first part comprises non-platoon-specific data elements and the second part comprises platoon-specific data elements; and
receive at least one basic safety message (BSM).

19. The receiver mobile station of claim 18, wherein the at least one PCM comprises a vehicle temporary identifier (ID) associated with at least one additional member vehicle, wherein the at least one BSM comprises the vehicle temporary ID, and wherein the one or more processors are further configured to:
receive at least one additional BSM comprising an updated vehicle temporary ID associated with the at least one additional member vehicle, and
receive at least one additional PCM comprising the updated vehicle temporary ID based.

20. The receiver mobile station of claim 19, wherein the one or more processors are further configured to identify an association between the at least one additional BSM and the at least one PCM based at least in part on motion state tracking information.

21. The receiver mobile station of claim 20, wherein the at least one additional BSM comprises motion data elements associated with the at least one additional member vehicle, and wherein the motion state tracking information comprises a predicted position value based at least in part on the motion data elements.

22. The receiver mobile station of claim 21, wherein the at least one PCM comprises a prior position value, and wherein the one or more processors, to identify the association, are configured to identify the association based at least in part on a difference between the predicted position value and a subsequent position value satisfying an uncertainty condition.

23. The receiver mobile station of claim 20, wherein the one or more processors are further configured to:
receive an indication of a size of the vehicle platoon;
receive an indication of a position of a lead vehicle of the vehicle platoon; and
identify a member vehicle of the at least one additional member vehicle that corresponds to a closest predicted position, of a plurality of predicted positions, to a position value indicated by the at least one additional BSM.

24. The receiver mobile station of claim 20, wherein the motion state tracking information comprises an indication of a lane index associated with the vehicle platoon.

25. The receiver mobile station of claim 19, wherein the one or more processors are further configured to receive a groupcast communication comprising an ID change indication that indicates the updated vehicle temporary ID.

26. The receiver mobile station of claim 18, wherein the one or more processors are further configured to:
transmit an extension request for at least one additional vehicle to extend a vehicle temporary ID duration, wherein transmitting the extension request comprises transmitting the extension request based at least in part on an occurrence of an ID extension condition; and
receive an extension configuration that indicates the ID extension condition.

27. A method of wireless communication performed by a transmitter mobile station associated with a member vehicle of a vehicle platoon, comprising:
transmitting, by the transmitter mobile station to at least one additional member vehicle of the vehicle platoon, at least one platoon control message (PCM) having a flexible structure, the at least one PCM comprising a first part and a second part that is different from the first part, wherein the first part comprises non-platoon-specific data elements and the second part comprises platoon-specific data elements; and
transmitting, by the transmitter mobile station, at least one basic safety message (BSM).

28. The method of claim 27, wherein at least one data element of the first part of the PCM is identical to at least one data element of the BSM, and wherein transmitting the at least one PCM comprises transmitting the at least one PCM using a cooperative transmission scheme to transmit the at least one PCM and the at least one BSM.

29. A method of wireless communication performed by a receiver mobile station associated with a member vehicle of a vehicle platoon, comprising:
receiving, by the receiver mobile station from at least one additional member vehicle of the vehicle platoon, at least one platoon control message (PCM) having a flexible structure, the at least one PCM comprising a first part and a second part that is different from the first part, wherein the first part comprises non-platoon-specific data elements and the second part comprises platoon-specific data elements; and
receiving, by the receiver mobile station from the at least one additional member vehicle of the vehicle platoon, at least one basic safety message (BSM).

30. The method of claim 29, wherein the at least one PCM comprises a vehicle temporary identifier (ID) associated with the at least one additional member vehicle, and wherein the at least one BSM comprises the vehicle temporary ID, the method further comprising:
receiving, by the receiver mobile station, at least one additional BSM comprising an updated vehicle temporary ID associated with the at least one additional member vehicle;
receiving, by the receiver mobile station, at least one additional PCM comprising the updated vehicle temporary ID based; and
identifying, by the receiver mobile station, an association between the at least one additional BSM and the at least one PCM based at least in part on motion state tracking information.
